(19) United States
(12) Patent Application Publication
(10) Pub. No.: US 2020/0044384 A1
(43) Pub. Date: Feb. 6, 2020

(54) WIRE WITH TERMINAL AND TERMINAL MANUFACTURING METHOD

(71) Applicant: Yazaki Corporation, Tokyo (JP)

(72) Inventor: Kei SATO, Makinohara-shi (JP)

(73) Assignee: Yazaki Corporation, Tokyo (JP)

(21) Appl. No.: 16/420,528

(22) PCT Filed: Apr. 26, 2017
(86) PCT No.: PCT/JP2017/016500

§ 371 Date: May 23, 2019

(30) Foreign Application Priority Data
Dec. 27, 2016 (JP) 2016-253774

(51) Int. Cl. H01R 13/52; H01R 4/18

(52) U.S. Cl. CPC H01R 13/5208; H01R 4/184; H01R 4/188

(57) ABSTRACT

The present invention suppresses the return of the barrel section while ensuring waterproofness against the contact portion with the aluminum core wire. A plurality of concave sections is dispersedly provided on the inner surface of the barrel section. A groove section is provided so as to overlap the sealing member. A ridge portion is provided extending in the crossing direction at a position which does not overlap with the sealing member in plan view and is close to the third region on the side opposite to the terminal section. The barrel section is crimped to the end portion by crimping so that the exposed portion of the aluminum core wire is in contact with the ridge portion, and is sealed with the sealing member.

### TECHNICAL FIELD

The present invention relates to an electric wire with terminal having a crimp terminal connected to a covered wire having an aluminum core wire and a terminal connection method for obtaining such a wire with terminal.

### BACKGROUND ART

In recent years, covered electric wires having aluminum core wires have been used for wire harnesses in place of covered electric wires having copper core wires. At this time, for example, some crimp terminals such as connector terminals are made of a copper alloy or the like, and the surface thereof is tin-plated or gold-plated. When crimp terminals of this type are crimped to the end portions of the covered electric wires where the aluminum core wires are exposed, contact between dissimilar metals occurs between the aluminum core wires and the crimping barrel section of the crimp terminal. If moisture adheres to such a contact portion, there is a possibility that the aluminum core made of aluminum, which is a base metal, is corroded due to so-called dissimilar metal corrosion.

Therefore, there has been proposed a crimp terminal surrounded by a sealing member around the contact portion between the barrel section and the aluminum core wire (see, for example, Patent Literature 1 and Patent Literature 2). According to such type of crimp terminal, moisture can be prevented from entering the contact portion of dissimilar metals, and generation of dissimilar metal corrosion as described above can be avoided.

FIG. 29 is a view showing an example of a conventional crimp terminal surrounding the contact portion between the barrel section and the aluminum core wire with a sealing member.

The crimp terminal 9 shown in FIG. 29 comprises a barrel section 91 and a terminal section 92, which are made of a metal plate such as a copper alloy by sheet metal working and subjected to tin plating or gold plating on the surface, and are arranged in the axial direction D91. The barrel section 91 is a portion that is wound around and crimped on the end portion W9a of the covered electric wire W9 having the aluminum core wire W91, the aluminum core wire W91 being exposed. The terminal section 92 is a female terminal connected to a pin terminal (not shown) as a connection object.

The barrel section 91 has a structure in which the metal plate is bent so that the cross section that intersects with the axial direction D91 is substantially U-shaped. After the end portion W9a of the covered electric wire W9 is placed on the inner surface 911 of the barrel section 91, the barrel section 91 is wound around the end portion W9a and crimped. A part of the inner surface 911 of the barrel section 91 is a contact portion 911a with the aluminum core wire W91 at the end portion W9a.

In the contact portion 911a, a serration 94 is formed in which a plurality of rows of grooves extending in an crossing direction D92 crossing the axial direction D91 in the plan view with respect to the contact portion 911a are arranged in the axial direction D91. When the barrel section 91 is wound around the end portion W9a and crimped, the edge of each groove forming the serration 94 bites into the aluminum core wire W91, so that satisfactory conduction between the covered electric wire W9 and the crimp terminal 9 can be obtained.

A sealing member 93 is provided so as to surround the contact portion 911a. When the barrel section 91 is wound around the end portion W9a and crimped, the sealing member 93 seals the gaps around the contact portion 911a and prevents moisture from entering.

### PRIOR ART DOCUMENT

### Patent Literature

Patent Literature 1: JP 5480368 B
Patent Literature 2: JP 5940198 B

### SUMMARY OF INVENTION

### Technical Problem

Here, in the case of the wire with terminal in which the crimp terminal as described above is crimped to the end portion of the covered electric wire, in many cases, a force tending to return to the original state against the crimping acts on the barrel section of the crimp terminal. At this time, the sealing member wound around the end portion of the covered electric wire together with the barrel section sometimes works to promote this return. Such a large return may cause deterioration in conductivity between the aluminum core wire and the crimp terminal in the wire with terminal, a reduction in crimping strength between the end portion of the covered wire and the crimp terminal, and the like.

Accordingly, an object of the present invention is to provide an electric wire with terminal capable of suppressing the return of the barrel section while securing waterproofness against a contact portion with an aluminum core wire, and a terminal connection method for obtaining such a wire with terminal.

### Solution to Problem

According to a first aspect of the present invention, there is provided an electric wire with terminal of which an end portion is connected to a crimp terminal in which a barrel section to be wound around and crimped to an end portion of a covered electric wire having an aluminum core wire at which the aluminum core wire is exposed, and a terminal section to be connected to a connection object are arranged in a predetermined axial direction,

wherein the barrel section includes: a bottom plate section extending in the axial direction, on which the end portion of the covered electric wire is to be placed; and an inner barrel piece and an outer barrel piece extending from the bottom plate section on both sides in a crossing direction intersecting the axial direction in plan view with respect to the bottom plate section,

wherein a sealing member formed of an adhesive gel is affixed across a first region that longitudinally traverses the outer barrel piece in the axial direction, a second region which traverses the inner surface in the crossing direction at a position close to the terminal section, and a third region that traverses the inner surface in the crossing direction so as to intersect a covered portion of the end portion,

wherein a plurality of concave sections is dispersedly provided on an inner surface of the barrel section, a groove section is provided on at least the third region so as to overlap the sealing member, and a ridge portion is provided extending in the crossing direction at a position which does not overlap with the sealing member in plan view and is close to the third region,

wherein the barrel section is crimped to the end portion by crimping so that the exposed portion of the aluminum core wire at the end portion is in contact with the ridge portion, and the sealing member seals between the inner barrel piece and the outer barrel piece, an opening of the barrel section which is to be cylindrical on a side of the terminal section, and between the covered portion and the barrel section.

In the electric wire with terminal of the present invention, the edge of each recess provided on the inner surface of the barrel section bites into the aluminum core wire by crimping, so that satisfactory conduction between the covered electric wire and the crimp terminal can be obtained. In the wire with terminal of the present invention, the sealing member is formed by an adhesive gel, and affixed to the inner surface of the barrel section, so that after crimping, the sealing member seals between the inner barrel piece and the outer barrel piece, an opening of the barrel section which is to be cylindrical on a side of the terminal section, and between the covered portion and the barrel section. This sealing member ensures waterproofness against the above-mentioned contact portion between the aluminum core wire and the inner surface of the barrel section.

Here, in the electric wire with terminal of the present invention, in order to make the exposed portion of the aluminum core wire come into contact with the ridge portion extending in the crossing direction at a position not overlapping the sealing member and at a position close to the third region, the barrel section is crimped to the end of the covered electric wire. The ridge portion extending in the crossing direction described above plays a role of resisting the return of the barrel after crimping. At this time, if the sealing member made of the flexible adhesive gel temporarily overlaps with the protruding portion and is wound around the end portion, it becomes a cushion at the time of crimping to widen the winding diameter at the ridge, and the above-mentioned role of the ridge portion may be weakened in some cases. However, in the wire with terminal of the present invention, since the exposed portion of the aluminum core wire is crimped to the above-mentioned ridge, the ridge portion comes into direct contact with the aluminum core wire without interposing the sealing member therebetween. Thereby, the ridge portion can resist the return of the barrel section without being affected by the sealing member. Further, since the ridge portion is wound without interposing the cover of the covered electric wire therebetween, the winding diameter is also suppressed by the thickness of the coating. Even in this point, it is possible to satisfactorily resist the return of the barrel section. As a result, the return of the barrel section is favorably suppressed. Thus, according to the wire with terminal of the present invention, it is possible to suppress the return of the barrel section while securing the waterproof property against the contact portion with the aluminum core wire. Further, since the ridge portion is in contact with the exposed portion of the aluminum core wire, the conductivity between the crimp terminal and the aluminum core wire can be improved.

Here, preferably, the inner surface of the barrel section is further provided with a second ridge portion extending in the crossing direction at a position close to the terminal section.

According to this preferable electric wire with terminal, it is possible to satisfactorily suppress the return of the barrel section at both the terminal section side of the barrel section and the opposite side thereof.

Further, in the electric wire with terminal of the present invention, it is preferable that the ridge portion is an indent portion formed so as to protrude from the inner surface of the barrel section. Likewise, in the above-described preferred wire with terminal provided with the second ridge portion of the barrel section close to the terminal section, it is more preferable that the second ridge portion may be indented so as to protrude from the inner surface of the barrel section.

According to these preferable electric wires with terminal, since the resistance against the return as described above is strong in the ridge portion and the second ridge portion as the indent portions, the return of the barrel section can be more satisfactorily suppressed.

Further, in the electric wire with terminal of the present invention, preferably, the barrel section is crimped to the end portion so that a tip of the covered portion at the end portion overlaps a portion of the sealing member affixed to the third region.

According to this preferred electric wire with terminal, the ridge portion is provided as close as possible to the third region and is brought into contact with the exposed portion of the aluminum core wire, so that it is possible to more effectively suppress the return at a position close to the end edge of the barrel section.

Further, in the electric wire with terminal of the present invention, it is also preferable that the barrel section is crimped to the end portion so that a tip of the aluminum core wire at the end portion overlaps with a portion of the sealing member affixed to the second region.

According to this preferable electric wire with terminal, a portion even slightly deviated in the above-mentioned axial direction from the portion affixed to the second region of the sealing member can immediately contribute to electrical conduction with the aluminum core wire. As a result, the conductivity between the aluminum core wire and the crimp terminal can be sufficiently secured.

According to a second aspect of the present invention, there is provided a terminal connection method for connecting a crimp terminal to an end portion of a covered electric wire, the crimp terminal in which a barrel section to be wound around and crimped to the end portion of the covered electric wire having an aluminum core wire at which the aluminum core wire is exposed, and a terminal section to be connected to a connection object are arranged in a predetermined axial direction,

wherein the barrel section includes: a bottom plate section extending in the axial direction, on which the end portion of the covered electric wire is to be placed; and an inner barrel piece and an outer barrel piece extending from the bottom plate section on both sides in a crossing direction intersecting the axial direction in plan view with respect to the bottom plate section,

wherein a sealing member formed of an adhesive gel is affixed across a first region that longitudinally traverses the outer barrel piece in the axial direction, a second region which traverses the inner surface in the crossing direction at a position close to the terminal section, and a third region that traverses the inner surface in the crossing direction so as to intersect a covered portion of the end portion,

wherein a plurality of concave sections is dispersedly provided on an inner surface of the barrel section, a groove section is provided on at least the third region so as to overlap the sealing member, and a ridge portion is provided extending in the crossing direction at a position which does not overlap with the sealing member in plan view and is close to the third region,

the method comprising:

a placing step of placing the end portion on the inner surface of the barrel section along the axial direction so that an exposed portion of the aluminum core wire at the end portion is in contact with the ridge portion; and

a crimping step of fixing the crimp terminal to the end portion by winding the barrel section around the end portion with the inner barrel piece arranged inside and by crimping, and sealing between the inner barrel piece and the outer barrel piece, an opening of the barrel section which is to be cylindrical on a side of the terminal section, and between the covered portion and the barrel section with the sealing member.

According to the terminal connecting method of the present invention, the barrel section to which the sealing member is affixed is wound around the end portion of the covered electric wire and crimped, whereby waterproofness against the above-mentioned contact portion between the aluminum core wire and the inner surface of the barrel portion is secured. Then, by crimping so that the exposed portion of the aluminum core wire is brought into contact with the above-mentioned ridge portion, the ridge portion can satisfactorily suppress return of the barrel section without being affected by the sealing member or the covered portion. As described above, according to the terminal connecting method of the present invention, it is possible to suppress the return of the barrel portion while securing the waterproof property against the contact portion with the aluminum core wire.

Further, in the terminal connection method of the present invention, preferably, the placing step is a step of placing the end portion on the inner surface of the barrel section so that a tip of the covered portion at the end portion overlaps with a portion of the sealing member affixed to the third region.

According to this preferable terminal connecting method, the ridge portion is provided as close as possible to the third region and is brought into contact with the exposed portion of the aluminum core wire, so that it is possible to more effectively suppress the return at a position close to the end edge of the barrel section.

Further, in the terminal connection method of the present invention, it is preferable that the placing step may be to place the end portion on the inner surface of the barrel section such that the tip of the aluminum core wire at the end portion overlaps with a portion of the sealing member affixed to the second region.

According to this preferable terminal connection method, a portion even slightly deviated in the above-mentioned axial direction from the portion affixed to the second region of the sealing member can immediately contribute to electrical conduction with the aluminum core wire. As a result, the conductivity between the aluminum core wire and the crimp terminal can be sufficiently secured.

Although only the mode related to the basic form of the terminal manufacturing method of the present invention has been described here, it goes without saying the preferred form of the above-mentioned wire with terminal of the present invention is applied as a suitable form for the terminal manufacturing method of the present invention.

### Effect of the Invention

According to the present invention, it is possible to obtain an electric wire with terminal capable of suppressing the return of the barrel section while securing waterproofness against a contact portion with an aluminum core wire, and a terminal connection method for obtaining such a wire with terminal.

### BRIEF DESCRIPTION OF DRAWINGS

FIG. 1 is an explanatory view for explaining a crimp terminal according to one embodiment of the present invention;

FIG. 2 is a schematic view showing how the seal member shown in FIG. 1 is affixed to an inner surface of a barrel section;

FIG. 3 is a view showing a procedure until preparations are made for crimping the crimp terminal shown in FIGS. 1 and 2 to an end portion of a covered electric wire with a terminal connecting method;

FIG. 4 is a view showing a procedure until the crimp terminal is crimped to the end portion of the covered electric wire following the procedure shown in FIG. 3;

FIG. 5 is a view showing the placing step shown in FIG. 4 in plan view with respect to the inner surface of the barrel section;

FIG. 6 is a view showing the wire with terminal after crimping also shown in FIG. 4;

FIG. 7 is a view showing a change during a crimping step in a cross section taken along line V11-V11, a cross section taken along line V12-V12, and a cross section taken along line V13-V13 in FIG. 6;

FIG. 8 is a schematic view showing how the gap between the second seal portion and the first seal portion, and between the third seal portion and the first seal portion shown in FIG. 2 is closed by extension of the seal member at the time of crimping;

FIG. 9 is a side view showing the wire with terminal in FIG. 6, as viewed in a direction of an arrow V15;

FIG. 10 is a sectional view taken along line V14-V14 in FIG. 6;

FIG. 11 is a view showing a first modification of the embodiment shown in FIGS. 1 to 10;

FIG. 12 is a view showing a second modification of the embodiment shown in FIGS. 1 to 10;

FIG. 13 is a view showing a third modification of the embodiment shown in FIGS. 1 to 10;

FIG. 14 is a view showing a fourth modification of the embodiment shown in FIGS. 1 to 10;

FIG. 15 is a view showing a fifth modification of the embodiment shown in FIGS. 1 to 10;

FIG. 16 is a view showing a sixth modification of the embodiment shown in FIGS. 1 to 10;

FIG. 17 is a view showing a seventh modification of the embodiment shown in FIGS. 1 to 10;

FIG. 18 is a view showing an eighth modification of the embodiment shown in FIGS. 1 to 10;

FIG. 19 is a view showing a ninth modification of the embodiment shown in FIGS. 1 to 10;

FIG. 20 is a view showing a tenth modification of the embodiment shown in FIGS. 1 to 10;

FIG. 21 is a view showing a eleventh modification of the embodiment shown in FIGS. 1 to 10;

FIG. 22 is a view showing a twelfth modification of the embodiment shown in FIGS. 1 to 10;

FIG. 23 is a view showing a thirteenth modification of the embodiment shown in FIGS. 1 to 10;

FIG. 24 is a view showing a fourteenth modification of the embodiment shown in FIGS. 1 to 10;

FIG. 25 is a view showing a fifteenth modification of the embodiment shown in FIGS. 1 to 10;

FIG. 26 is a view showing a sixteenth modification of the embodiment shown in FIGS. 1 to 10;

FIG. 27 is a view showing a seventeenth modification of the embodiment shown in FIGS. 1 to 10;

FIG. 28 is a view showing a eighteenth modification of the embodiment shown in FIGS. 1 to 10; and

FIG. 29 is a view showing an example of a conventional crimp terminal surrounding a contact portion between a barrel section and an aluminum core wire with a seal member.

### DESCRIPTION OF EMBODIMENTS

Hereinafter, one embodiments of the present invention will be described with appropriate modifications.

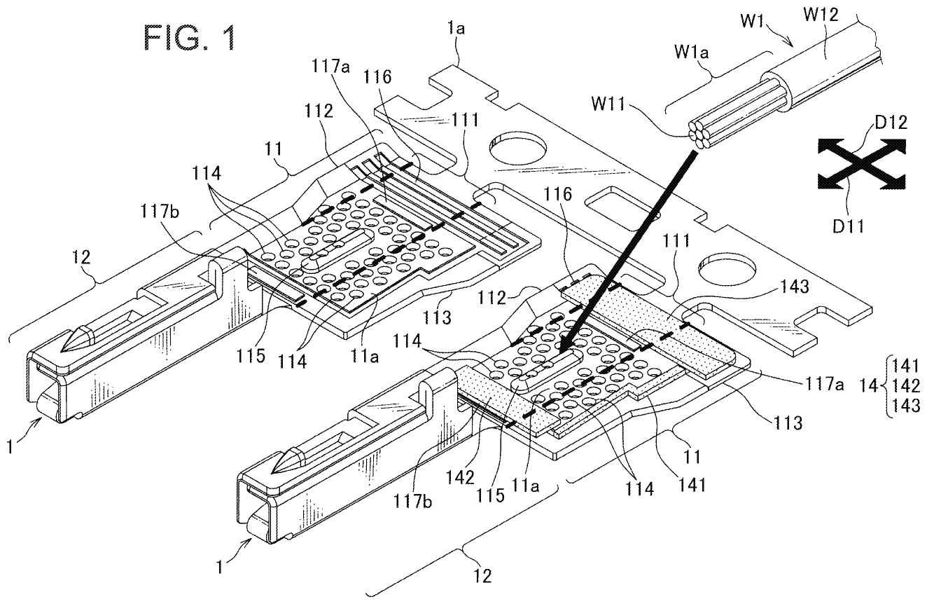

FIG. 1 is an explanatory view for explaining a crimp terminal according to one embodiment of the present invention.

A crimp terminal 1 according to the present embodiment is crimped to an end portion W1a of a covered electric wire W1 exposing an aluminum core wire W11. The crimp terminal 1 includes a barrel section 11, a terminal section 12, and a seal member 14. Although two crimp terminals 1 are shown in FIG. 1, one crimp terminal 1 is shown with the seal member 14 removed so that an inner surface shape of the barrel section 11 can be visually observed.

The barrel section 11 and the terminal section 12 are made from a metal plate such as a copper alloy by punching and sheet metal working, and its surface is subjected to tin plating or gold plating. The barrel section 11 and the terminal section 12 are arranged in a predetermined axial direction D11. Here, in the present embodiment, the barrel section 11 and the terminal section 12 are collectively formed in a state in which a plurality of crimp terminals 1 are connected by a strip-like connecting piece 1a. The barrel section 11 is a plate-like portion wound and wound around the end portion W1a of the covered electric wire W1 so as to wrap around the aluminum core wire W11 and the covered portion W12 in a circumferential direction. In the present embodiment, the barrel section 11 is core-cover integral barrel in which a portion enclosing the aluminum core wire W11 and a portion enclosing the covered portion W12 are integrated. The terminal section 12 is a square tubular female terminal connected to a pin terminal (not shown) as a connection object.

The barrel section 11 has a bottom plate section 111, an inner barrel piece 112, and an outer barrel piece 113. The bottom plate section 111 extends in the above-mentioned axial direction D11. The inner barrel piece 112 and the outer barrel piece 113 extend from the bottom plate section 111 on both sides in a crossing direction D12 intersecting the axial direction D11 in plan view with respect to the bottom plate section 111. When crimping the end portion W1a of the covered electric wire W1, the barrel section 11 is wound around the end portion W1a with the inner barrel piece 112 inside and the outer barrel piece 113 outside as described later.

Here, a plurality of concave sections 114 is dispersedly provided on an inner surface 11a of the barrel section 11. Each concave section 114 is formed in a circular shape in plan view with respect to the inner surface 11a of the barrel section 11. Further, a convex section 115 is formed on the bottom plate section 111 of the barrel section 11 by press working from an outer surface side at a position where the aluminum core wire W11 at the end portion W1a of the covered electric wire W1 is placed. A part of the plurality of concave sections 114 is also formed on the convex section 115.

A seal member 14 formed of an adhesive gel sheet is affixed to the inner surface 11a of the barrel section 11 so as to surround the plurality of concave sections 114 from three sides in a plan view. The seal member 14 is affixed as follows. Incidentally, examples of the adhesive gel sheet include, for example, those using acrylic adhesives, but the present invention is not limited thereto.

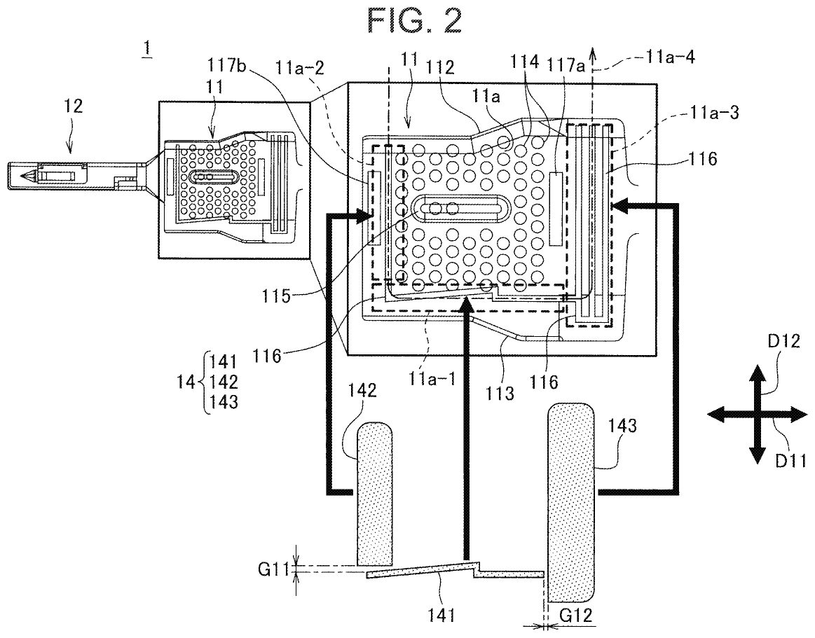

FIG. 2 is a schematic view showing how the seal member shown in FIG. 1 is affixed to the inner surface of the barrel section.

The sealing member 14 is formed of an adhesive gel sheet and is arranged over three regions of the first region 11a-1, the second region 11a-2, and the third region 11a-3 on the inner surface 11a of the barrel section 11. The first region 11a-1 is a region that longitudinally traverses the outer barrel piece 113 in the axial direction D11. The second region 11a-2 is an area that traverses the inner surface 11a in the crossing direction D12 closer to the terminal section 12. The third region 11a-3 is an area traversing the inner surface 11a in the crossing direction D12 so as to intersect the covered portion W12 of the end portion W1a.

As shown in FIGS. 1 and 2, in the present embodiment, the seal member 14 is composed of three portions, a first seal portion 141, a second seal portion 142, and a third seal portion 143. The first seal portion 141 extends in a band shape in the axial direction D11 in the first region 11a-1. The second seal portion 142 extends in a band shape in the crossing direction D12 in the second region 11a-2. The third seal portion 143 extends in a band shape in the crossing direction D12 in the third region 11a-3.

In the present embodiment, groove sections 116 are formed on the inner surface 11a of the barrel section 11 so as to overlap the sealing member 14 in the first region 11a-1, the second region 11a-2, and the third region 11a-3. In the first region 11a-1, one groove section 116 extends in the axial direction D11 while bending in a sawtooth shape in the middle. In the second area 11a-2, one groove section 116 extends linearly in the crossing direction D12, in the third area 11a-3, three grove sections 116 extend linearly in the crossing direction D12, and on a side of the first area 11a-1, they are joined together. Further, the plurality of concave portions 114 is provided avoiding the groove sections 116.

Furthermore, in the present embodiment, on the inner surface 11a of the barrel section 11, a first indent portion 117a is provided as a ridge extending in the crossing direction D12 at a position closer to the center than the third region 11a-3 in plan view. Further, a second indent portion 117b is provided as a ridge extending in the crossing direction D12 at a position closer to the terminal section 12 than the groove section 116 and partially overlapping with the second region 11a-2.

In the present embodiment, the seal member 14 is attached in a state of being divided in a halfway of a path 11a-4 extending from the second region 11a-2 through the first region 11a-1 to the third region 11a-3. Specifically, the seal member 14 is attached in a state where both the second seal portion 142 and the third seal portion 143 are separated from the first seal portion 141. The second seal portion 142 is attached in a state where the second seal portion 142 is separated from the first seal portion 141 across the path 11a-4 in the axial direction D11. On the other hand, the third seal portion 143 is attached to the first seal portion 141 in a state where the third seal portion 143 crosses the path 11a-4 in the crossing direction D12. A slight gap G11 opens between the second seal portion 142 and the first seal portion 141, and a slight gap G12 opens between the third seal portion 143 and the first seal portion 141.

Here, the second seal portion 142 of the seal member 14 to be affixed to the second region 11a-2 is formed in a belt shape with a wide width so that a part thereof is extruded from the opening of the cylindrical barrel portion 11 after the crimping. On the other hand, the first seal portion 141 affixed to the first region 11a-1 is narrower than the second seal portion 142 and formed in a shape corresponding to the groove section 116 in the first region 11a-1. Specifically, the first seal portion 141 is formed to have approximately the same width and substantially the same shape as the groove section 116 so as to be accommodated inside the groove section 116. The third seal portion 143 affixed to the third region 11a-3 is formed in a band shape slightly wider than the second seal portion 142.

The first seal portion 141, the second seal portion 142, and the third seal portion 143 are affixed so that they respectively overlap the first region 11a-1, the second region 11a-2, and the third region 11a-3 of the groove section 116. In particular, regarding the first seal portion 141, as described above, the first seal portion 141 is affixed so as to be accommodated inside the groove section 116.

The crimp terminal 1 described above is manufactured as follows.

Firstly, a sheet metal working step of forming a structure before attachment of the seal member 14 is performed. In the sheet metal working step, the barrel section 11 is formed from a metal plate together with the terminal section 12. As described above, in the present embodiment, in the sheet metal working process, the barrel section 11 and the terminal section 12 are collectively formed in a state in which a plurality of crimp terminals 1 are connected by the strip-like connecting piece 1a. In this sheet metal working step, formation of a plurality of concave sections 114, formation of convex sections 115, and formation of groove sections 116 on the inner surface 11a of the barrel section 11 are also performed.

Subsequently, the seal member 14 is formed with an adhesive gel sheet, and the seal member affixing step of affixing the seal member 14 over the first area 11a-1, the second area 11a-2, and the third area 11a-3 is performed. In this the seal member affixing step, the seal member 14 is affixed in a state where the seal member 14 is divided in a halfway of the path 11a-4 from the second region 11a-2 to the third region 11a-3 via the first region 11a-1. That is, the first seal portion 141, the second seal portion 142, and the third seal portion 143 are individually affixed to the inner surface 11a of the barrel section 11.

In addition, in the sealing member affixing step, the first seal portion 141, the second seal portion 142, and the third seal portion 143 are punched out from the adhesive gel sheet and affixed to the inner surface 11a of the barrel section 11. By pushing the adhesive gel sheet toward each of the affixing points on the inner surface 11a of the barrel section 11 while punching out the adhesive gel sheet with the die punching cutter of each seal portion, punching out and affixing are performed substantially at the same time. At this time, the second seal portion 142 is affixed so as to overlap with a part of the second indent portion 117b, and the third seal portion 143 is affixed so as to expose the first indent portion 117a.

The crimp terminal 1 manufactured in this manner is crimped to the end portion W1a of the covered electric wire W1 by the following terminal connection method.

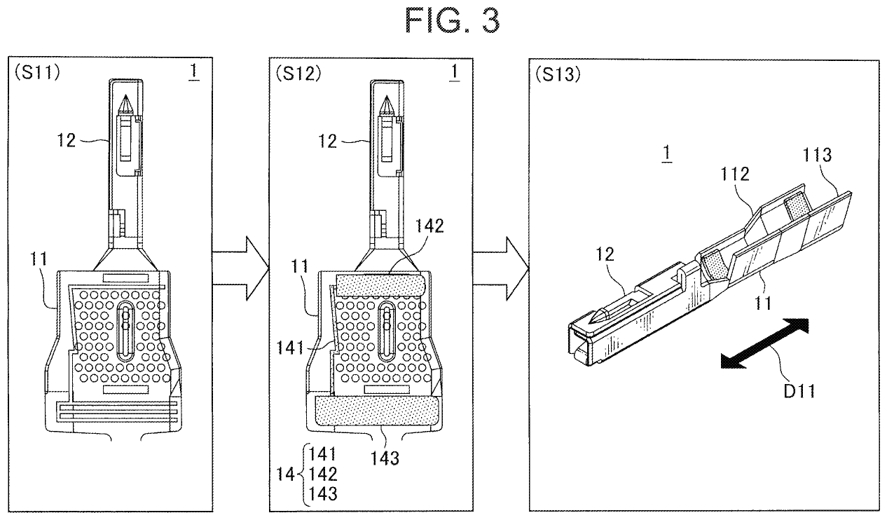

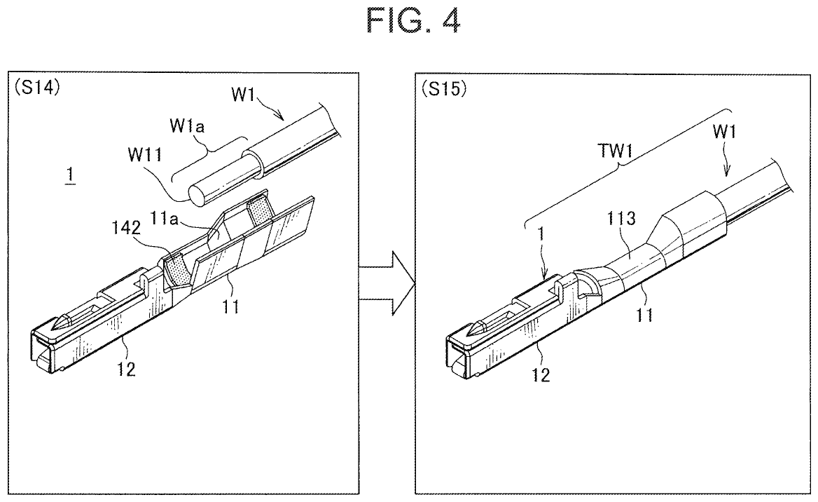

FIG. 3 is a view showing a procedure until preparations are made by the terminal connecting method for crimping the crimp terminal shown in FIGS. 1 and 2 to an end portion of a covered electric wire, and FIG. 4 is a view showing a procedure until the crimp terminal is crimped to the end portion of the covered electric wire following the procedure shown in FIG. 3.

FIG. 3 shows the sheet metal working step (S11) and also shows the sealing member affixing step (S12) in the terminal manufacturing method described above. In the sheet metal working step (S11), the barrel section 11 and the terminal section 12 are formed, and in the sealing member affixing step (S12), the first seal portion 141, the second seal portion 142 and the third seal portion 143 constituting the seal member 14 are affixed.

When crimping the end portion W1a of the covered electric wire W1, firstly, the crimp terminal 1 to be crimped is separated from the connecting piece 1a shown in FIG. 1. Then, for the barrel section 11, bending deformation is performed as preparation for placing the end portion W1a of the covered electric wire W1 (S13). This bending deformation is performed such that the inner barrel piece 112 and the outer barrel piece 113 are brought close to each other so that the cross section intersecting with the axial direction D11 is substantially U-shaped.

Subsequently, the placing step of placing the end portion W1a of the covered electric wire W1 on the barrel section 11 after the bending deformation is performed as follows (S14).

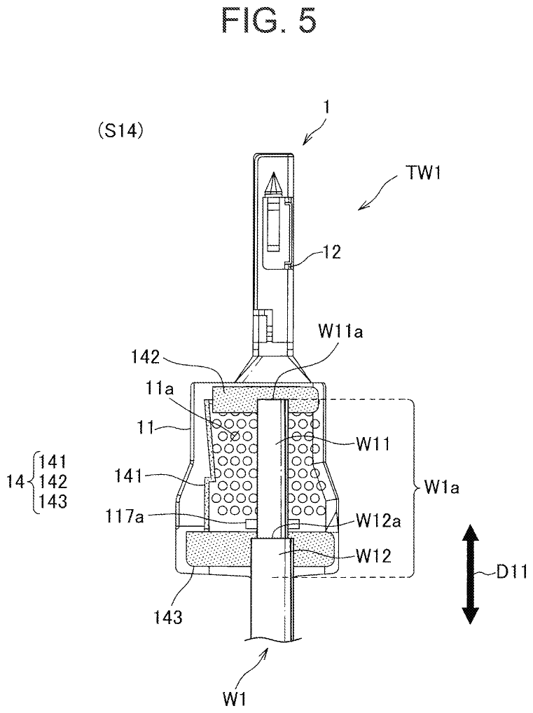

FIG. 5 is a view showing the placing step shown in FIG. 4 in plan view with respect to the inner surface of the barrel section. Incidentally, in FIG. 5, in order to make the positional relationship between the end portion W1a of the covered electric wire W1 and each portion on the inner surface 11a of the barrel section 11 easier to see, the barrel section 11 shown in a curved shape in FIG. 4 is shown in a flatly extended state.

In the placing step (S14), the end portion W1a is placed on the inner surface 11a of the barrel section 11 along the axial direction D11 so that the end portion W11a of the aluminum core wire W11 at the end portion W1a overlaps with the second seal portion 142 of the sealing member 14. Further, in this placing step (S14), the end portion W1a is placed on the inner surface 11a of the barrel section 11 so that the tip end W12a of the covered portion W12 overlaps with the third seal portion 143 of the sealing member 14. Further, in this placing step (S14), the exposed portion of the aluminum core wire W11 is placed so as to be in contact with the first indent portion 117a.

Following the placing step (S14) described above, as shown in FIG. 4, the crimping step (S15) is performed in which the barrel section 11 is wound around the end portion W1a and crimped so that the outer barrel piece 113 is overlapped with the inner barrel part 112 facing inward. With this crimping step (S15), the wire TW1 with terminal in which the crimp terminal 1 is connected to the covered wire W1 is completed.

Here, in the crimping step (S15), the sealing member 14 seals each part of the crimp terminal 1 as follows, and the wire with terminal TW1 is formed.

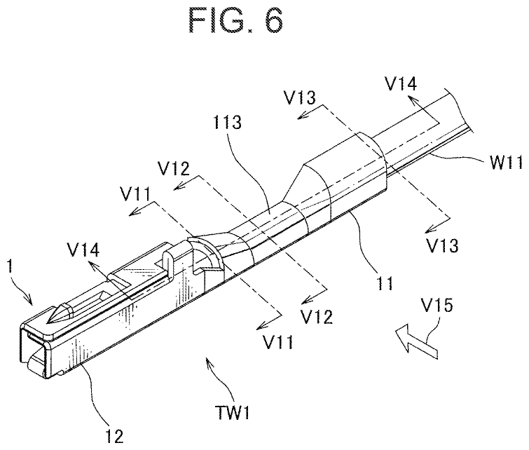

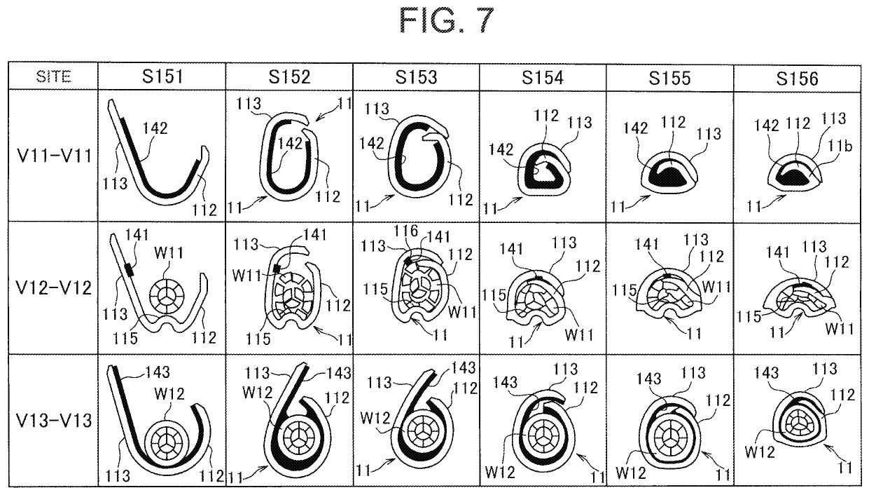

FIG. 6 is a view showing the wire with terminal after crimping also shown in FIG. 4. FIG. 7 is a view showing a change during the crimping step in a cross section taken along line V11-V11, a cross section taken along line V12-V12, and a cross section taken along line V13-V13 in FIG. 6.

In the first step (S151) of the crimping step, bending of the inner barrel piece 112 and the outer barrel piece 113 is started so as to wind around the aluminum core wire W11 on the convex section 115 and the covered portion W12 in the vicinity thereof. At this time, the first seal portion 141 is in contact with the aluminum core wire W11, the third seal portion 143 is in contact with the covered portion W12, and almost none of the second seal portion 142 contacts. In the second step (S152) and the third step (S153) in which the winding is slightly advanced, the barrel section 11 has a tubular shape. Then, the first seal portion 141 is sandwiched between the inner barrel piece 112 and the outer barrel piece 113, and the third seal part 143 is extended in a state sandwiched between the covering portion W12 and the barrel section 11.

At this time, in the present embodiment, since the first seal portion 141 is formed to have a width and shape corresponding to the groove section 116, the amount of the sealing member 14 sandwiched between the inner barrel piece 112 and the outer barrel piece 113 is minimized. If the amount of the sealing member 14 at this portion is too large, there is a case that the outer barrel piece 113 may be difficult to move with respect to the inner barrel piece 112 at the time of winding and hindering crimping. In contrast, in the present embodiment, since the amount of the sealing member 14 at this portion is suppressed, such interference by the sealing member 14 at the time of crimping can be prevented.

In the fourth step (S154), the fifth step (S155), and the sixth step (S156) where pressure is applied to the aluminum core wire W11 etc., the edges of the plurality of concave sections 114 dig into the aluminum core wire W11. At this time, the strands of the aluminum core wire W11 are spread by the convex section 115 located under the aluminum core wire W11, and the number of contacts between the barrel section 11 and these strands increases. At the same time, the extension of the seal member 14 also proceeds.

Here, as described above, in the present embodiment, a slight gap G11 opens between the second seal portion 142 and the first seal portion 141, and a slight gap G12 opens between the third seal portion 143 and the first seal portion 141. Theses gaps G11, G12 are closed by extension of the seal member 14 during crimping.

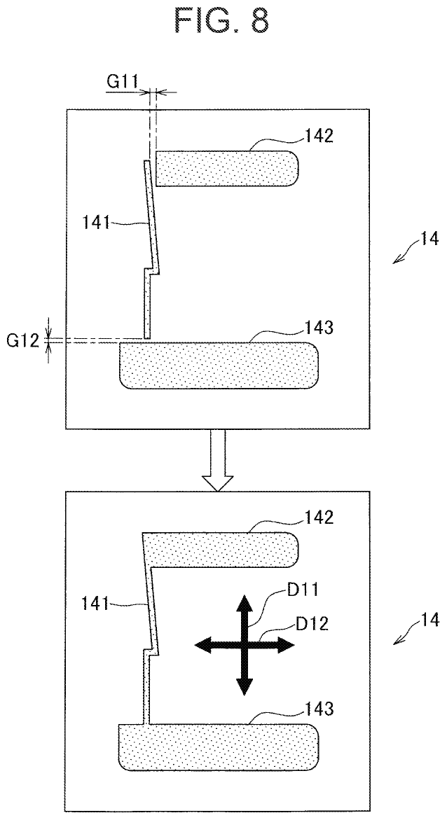

FIG. 8 is a schematic view showing how the gap between the second seal portion and the first seal portion, and between the third seal portion and the first seal portion shown in FIG. 2 is closed by extension of the seal member at the time of crimping.

As shown in FIG. 8, at the time of crimping, the second seal portion 142 is extended in the crossing direction D12 which coincides with a length direction thereof. Due to this extension, the second seal portion 142 is connected to the first seal portion 141, and the gap G11 is closed. On the other hand, the first seal portion 141 is extended in the axial direction D11 coincident with the longitudinal direction thereof. Due to this extension, the first seal portion 141 is connected to the third seal portion 143, and the gap G12 therebetween is closed.

Next, in the sixth step (S156), a space between the inner barrel piece 112 and the outer barrel piece 113, the opening 11b of the tubular barrel section 11 on a side of the terminal section 12, and a space between the covered portion W12 and the barrel section 11 are sealed by the extended sealing member 14.

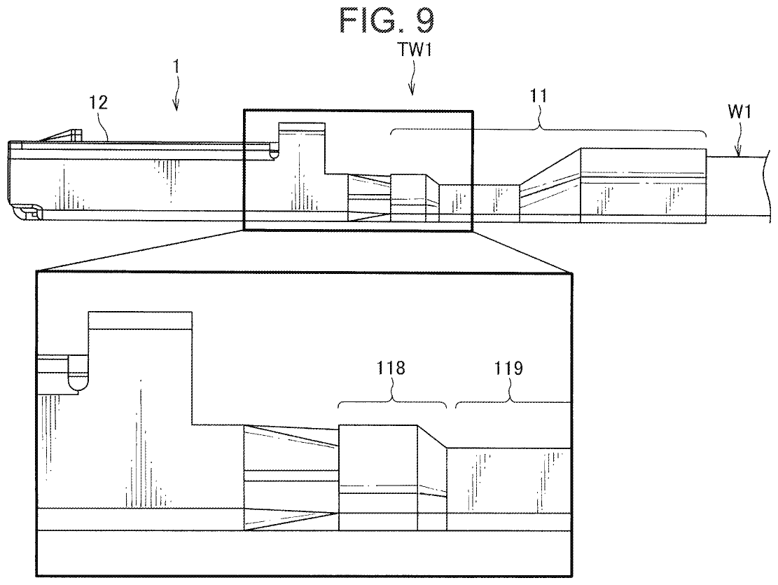

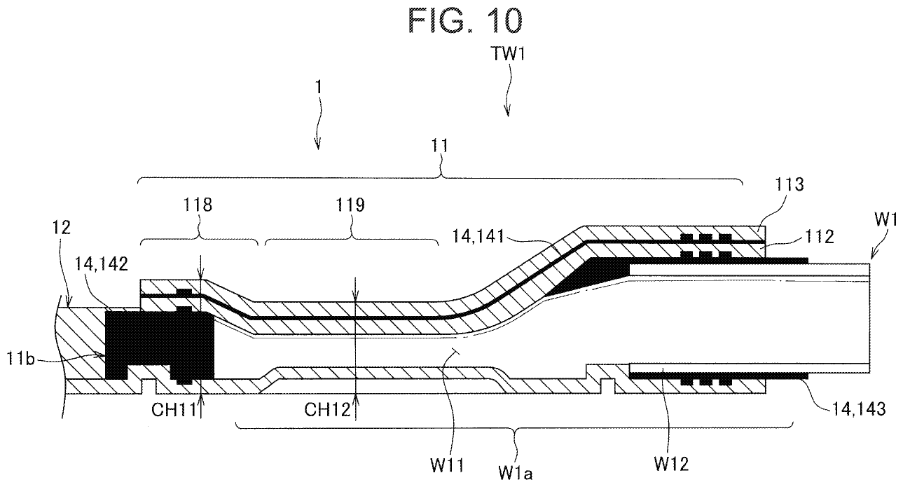

FIG. 9 is a side view showing the wire with terminal in FIG. 6, as viewed in a direction of an arrow V15, and FIG. 10 is a sectional view taken along line V14-V14 in FIG. 6.

As shown in FIG. 10, the space between the inner barrel piece 112 and the outer barrel piece 113 is sealed by the first seal portion 141, and the opening 11b of the barrel section 11 on the side of the terminal section 12 is sealed by the second seal portion 142. Further, a space between the covered portion W12 and the barrel section 11 is sealed by the third seal portion 143.

Here, in the present embodiment, a dimension of the barrel section 11 after the crimping (hereinafter referred to as the crimp height CH11) at a side of the terminal portion 12 (hereinafter referred to as the front end portion 118) in the vertical direction in FIG. 10 is set to the following dimension. That is, the crimp height CH11 of the front end portion 118 is crimped so as to be larger than the crimp height CH12 of the crimp portion 119 of the aluminum core wire W11.

At this time, as described above, the second seal portion 142 of the seal member 14 located on the side of the terminal portion 12 is formed in a band shape with a width that is partly extruded from the opening 11b of the barrel section 11 after crimping. As a result, as shown in FIG. 10, a part of the seal member 14 protrudes from the opening 11b of the front end portion 118 formed by the crimp height CH11 as described above. In other words, the crimp height CH11 of the front end portion 118 is set to such a size that the cylindrical barrel section 11 is crushed to such an extent that the sealing member 14 protrudes.

By the protrusion of the seal member 14 from the opening 11b, the opening 11b of the barrel section 11 is sealed at a high level. Further, a part of the seal member 14 also protrudes from between the covered portion W12 and the barrel section 11 on the extending side of the covered electric wire W1 in the barrel section 11 to seal this portion at a high level. On the other hand, the space between the inner barrel piece 112 and the outer barrel piece 113 is sealed by the minimum amount of the first seal portion 141 formed in a width and shape corresponding to the groove section 116. As a result, the barrel section 11 is hermetically sealed at various places while suppressing the hindrance of the crimping by the seal member 14.

Further, by forming each portion of the seal member 14 so as to protrude from the opening 11b of the barrel section 11 or from the extending side of the covered electric wire W1, it is possible to visually check that these portions are surely sealed with the seal member 14 after crimping. Then, by relatively reducing the crimp height CH12 of the crimping portion 112 as described above, the crimping of the aluminum core wire W11 is strengthened, and the contact reliability with the crimp terminal 1 is improved.

In the embodiment described above, the edges of the respective concave sections 114 provided on the inner surface 11a of the barrel section 11 by crimping bites into the aluminum core wire W11, whereby good conduction between the covered electric wire W1 and the crimp terminal 1 can be obtained. Then, the seal member 14 is affixed to the inner surface 11a of the barrel section 11 to seal between the inner barrel piece 112 and the outer barrel piece 113, the opening 11b of the cylindrical barrel section 11 on the terminal section 12 side, and the space between the covered part W12 and the barrel section 11 after crimping. Here, in the present embodiment, the second seal portion 142 affixed to the second region 11a-2 of the seal member 14 is formed in a belt shape with a width that is partly extruded from the opening 11b after crimping. On the other hand, the first seal portion 141 affixed to the first region 11a-1 is formed in a width and shape corresponding to the groove section 116. The waterproof property against the contact portion with the aluminum core wire W11 is obtained over the entire periphery thereof by the seal member 14. Particularly, the waterproofness of the opening 11b close to the aluminum core wire W11 is enhanced by the second seal portion 142 formed in a belt shape with a width that is partly extruded from the opening 11b after crimping. Then, the first seal portion 141 is formed in a width and shape corresponding to the groove section 116 of the first region 11a-1, so that the amount is minimized and hindrance caused by the seal member 14 is suppressed when winding the inner barrel piece 112 inside and crimped. As described above, according to the present embodiment, difficulty in manufacturing can be alleviated while ensuring waterproofness against the contact portion with the aluminum core wire W11.

Here, in the present embodiment, the groove section 116 is also provided in the third region 11a-3 so as to extend in the crossing direction D12. Since the groove section 116 provided in the third region 11a-3 plays a role of suppressing the displacement of the third seal portion 143 at the time of crimping, it is possible to further alleviate difficulties in manufacturing. Similarly, the groove section 116 is also provided in the second region 11a-2 so as to extend in the crossing direction D11. Since the groove section 116 of the second region 11a-1 plays a role of suppressing positional displacement of the second seal portion 142 at the time of crimping, in the present embodiment, in all the affixing portions of the seal member 14, the positional deviation at the time of crimping is suppressed and the manufacturing difficulty is further alleviated.

Further, in the present embodiment, the groove section 116 is provided so as to extend in three rows in the axial direction D11 in the third region 11a-3. As a result, since the groove section 116 is provided in three rows in the third region 11a-3 which intersects with the covered portion W12 which is easy to move during crimping or the like, the positional displacement of the third seal portion 143 affixed to the third region 11a-3 is further suppressed. This makes it possible to further alleviate manufacturing difficulties.

In the terminal connecting method of this embodiment described with reference to FIGS. 3 to 4, in the above-described placing step (S14), the end portion W1a of the covered electric wire W1 is formed on the inner surface 11a of the barrel section 11 as follows. That is, the end portion W1a of the covered electric wire W1 is placed such that the tip W11a of the aluminum core wire W11 overlaps with the second seal portion 142 of the seal member 14 close to the terminal section 12. Thereby, a portion even slightly deviated from the second seal portion 142 in the axial direction D11 can immediately contribute to electrical conduction with the aluminum core wire W11. As a result, the electrical conductivity between the aluminum core wire W11 and the crimp terminal 1 is sufficiently secured. As described above, according to the terminal connecting method of the present embodiment, it is possible to ensure sufficient electrical conductivity between the exposed aluminum core W11 and the crimp terminal 1 while securing waterproofness against a contact portion with the aluminum core wire W11.

Here, in the present embodiment, the placing step (S14) includes the step of placing the end W1a on the inner surface 11a of the barrel section 11 so that the tip end W12a of the covered portion W12 overlaps with the third seal portion 143. As a result, the portion between the second seal portion 142 and the third seal portion 143 in the axial direction D11 contributes to electrical conduction with the aluminum core wire W11 over substantially the entire length. Thereby, the conductivity between the exposed aluminum core wire W11 and the crimp terminal 1 can be further improved.

Further, as shown in FIG. 2, in the electric wire with terminal TW1 of the present embodiment, the first indent portion 117a is provided at the position not overlapping with the seal member 14 and closer to the third region 11a-3. Then, as shown in FIG. 5, the barrel portion 11 is crimped to the end portion W1a of the covered electric wire W1 so that the aluminum core wire W11 is in contact with the first indent portion 117a.

The first indent portion 117 a extending in the crossing direction D12 plays a role of resisting the return of the barrel section 11 after crimping. At this time, when the seal member 14 made of a flexible adhesive gel overlaps with the first indent portion 117a and is wound around the end portion W1a, there is a case where the seal member 14 may behave as follows. That is, there is a case that a portion overlapping with the first indent portion 117a may serve as a cushion at the time of crimping to widen the winding diameter at the first indent portion 117a to weaken the role of the first indent portion 117a.

However, in the present embodiment, the first indent portion 117a is directly contacted with the aluminum core wire W11 without interposing the sealing member 14. Accordingly, the first indent portion 117a can resist the return of the barrel section 11 without being affected by the seal member 14. Further, since the first indent portion 117a is wound without interposing the coating of the covered electric wire W1 therebetween, the wound diameter is also suppressed with respect to the thickness of the covering. Even in this point as well, the return of the barrel section 11 can be satisfactorily resisted. As a result, the return of the barrel section 11 is favorably suppressed. As described above, according to the present embodiment, it is possible to suppress the return of the barrel section 11 while ensuring the waterproof property against the contact portion with the aluminum core wire W11. In addition, since the first indent portion 117a directly contacts the aluminum core wire W11, the conductivity between the crimp terminal 1 and the aluminum core wire W11 can also be sufficiently secured.

Here, in the present embodiment, as shown in FIG. 2, a second indent portion 117b extending in the crossing direction D12 is also provided on the inner surface 11a of the barrel section 11 at a position close to the terminal portion 12. As a result, the return of the barrel section 11 can be satisfactorily suppressed by both of the vicinity of the terminal portion 12 of the barrel section 11 and the opposite side thereof.

Further, in the present embodiment, the first indent portion 117a and the second indent portion 117b obtained by sheet metal working are employed as the ridge portion of the inner surface 11a of the barrel portion 11. Generally, since the resistance of the indent portion against the return as described above is strong, the return of the barrel section 11 can be more satisfactorily suppressed.

Further, in the present embodiment, as shown in FIG. 5, the barrel section 11 is crimped at the end portion W1a of the covered electric wire W1 so that the tip end W12a of the covered portion W12 at the end portion W1a overlaps with the third seal portion 143. In view of this, in the present embodiment, the first indent portion 117a is provided as close as possible to the third region 11a-3. According to the present embodiment, by bringing the aluminum core wire W11 into contact with the first indent portion 117a at such a position, return can be more effectively suppressed at a position close to the end edge of the barrel section 11.

Further, in the terminal connecting method of the present embodiment described with reference to FIGS. 3 to 4, in the placing step (S14), the end portion W1a is placed on the inner surface 11a of the barrel section 11 so that the aluminum core wire W11 is in contact with the first indent portion 117 a. As a result, as described above, the return of the barrel portion 11 can be favorably suppressed without the first indent portion 117a being affected by the seal member 14. As described above, according to the terminal connecting method of the present embodiment, it is possible to suppress the return of the barrel section 11 while ensuring the waterproof property against the contact portion with the aluminum core wire W11.

Further, in the terminal connecting method of the present embodiment, the placing step (S14) is a step of placing the end portion W1a on the inner surface 11a of the barrel section 11 so that the tip end W12a of the covered portion W12 overlaps with the third seal portion 143. Thus, as described above, it is possible to more effectively suppress the return at a position close to the end edge of the barrel section 11.

Further, in the terminal connecting method of the present embodiment, the placing step (S14) is a step of placing the end portion W1a on the inner surface 11a of the barrel section 11 so that the tip end W11a of the aluminum core wire W11 overlaps with the second seal portion 142. As also described above, the conductivity between the aluminum core wire W11 and the crimp terminal 1 can be sufficiently secured.

Next, various modified examples of the above-described embodiment will be described.

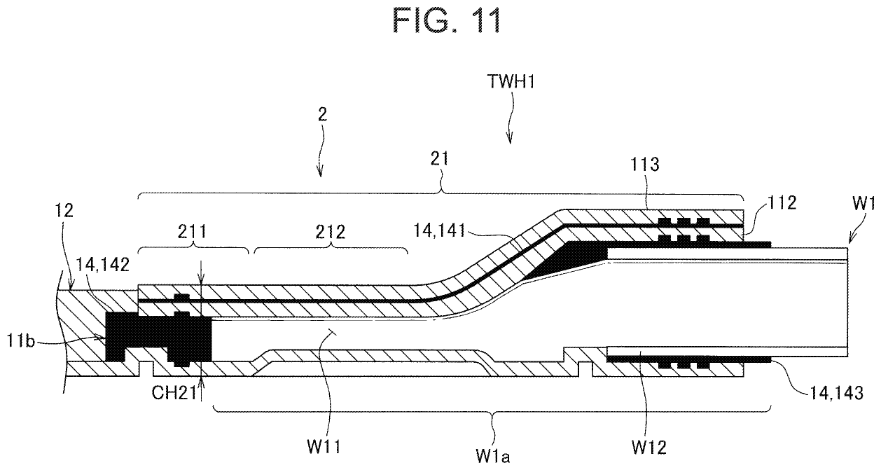

FIG. 11 is a view showing a first modification of the embodiment shown in FIGS. 1 to 10. Incidentally, in FIG. 11, the same reference numerals are given to the same constituent elements as those shown in FIGS. 1 to 10, and in the following, redundant description of these equivalent elements will be omitted. This also applies to drawings to be referred to in other modified examples to be described later and to descriptions of modifications thereof.

In the wire with terminal TWH 1 of the first modified example, the crimp terminal 2 is crimped so that the crimp height CH 21 of the same degree can be obtained by the front end portion 211 of the barrel section 21 and the crimp portion 212 of the aluminum core wire W11 after crimping. Then, the second seal portion 142 of the sheet member 14 is formed into a band shape with a width that is partially extruded from the opening 11b by the crimp height CH21 at this time. Also in this first modification, while preventing interference of the crimping by the seal member 14 with the minimum amount of the first seal portion 141, for the opening 11b requiring a relatively large amount for sealing, sealing is performed by the second seal portion 142 having the width as described above.

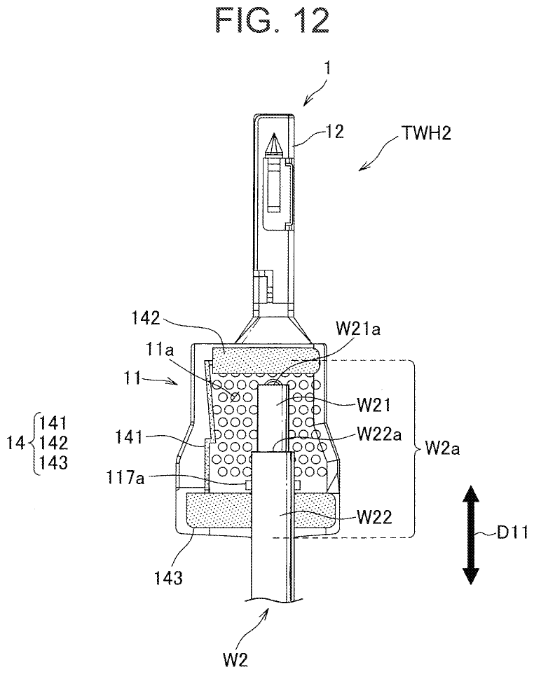

FIG. 12 is a view showing a second modification of the embodiment shown in FIGS. 1 to 10.

The wire with terminal TWH2 of the second modification differs from the above-described embodiment in the state of placement of the end portion W2a of the covered electric wire W2 on the inner surface 11a of the barrel section 11. That is, in the second modification, the end W2a of the covered electric wire W2 is provided on the inner surface 11a of the barrel section 11 so that the tip end W21a of the aluminum core wire W21 is detached from the second seal portion 142 on the side opposite to the terminal portion 12. Furthermore, in this second modification, the end portion W2a of the covered electric wire W2 is placed on the inner face 11a of the barrel section 11 so that the tip end W22a of the covered portion W22 is detached from the third seal portion 143 toward the terminal portion 12. As a result, in the second modification, the crimp terminal 1 is crimped onto the covered wire W2 so that the covered portion W22 is in contact with the first indent portion 117a.

Compared with the second modification, the above-described embodiment makes it possible to contribute to electrical conduction over a longer range on the inner surface 11a of the barrel section 11 in the axial direction D11, and ensures sufficient conductivity as described above. Further, in the above-described embodiment, since the first indent portion 117a is wound directly in contact with the aluminum core wire W11, the winding diameter is suppressed by the thickness of the covered portion and the return of the barrel section 11 can be favorably suppressed as described above.

On the other hand, also in this second modification, the second seal portion 142 is formed like a band with a width that is partly extruded from the opening 11b of the barrel section 11 after crimping, and the first seal portion 141 has a width corresponding to the groove section 116 in the same manner as the above-described embodiment. Therefore, it is needless to say that it is possible to alleviate the difficulty in manufacturing, while ensuring the waterproof property against the contact portion with the aluminum core wire W21, also in this second modification similar to the above embodiment.

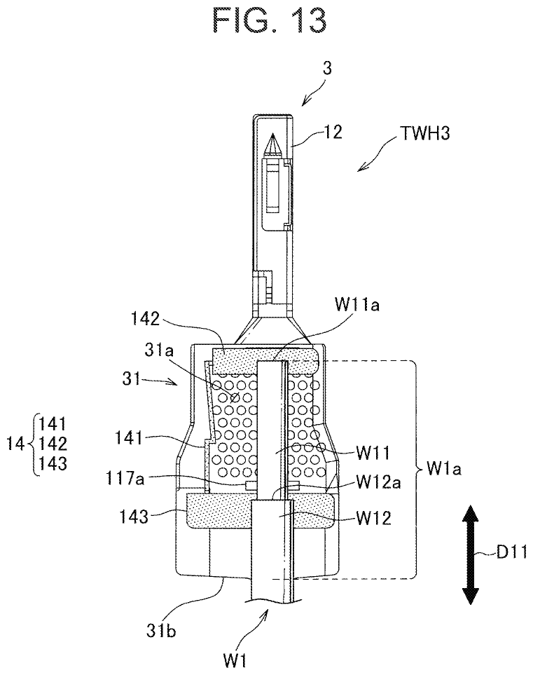

FIG. 13 is a view showing a third modification of the embodiment shown in FIGS. 1 to 10.

In the wire with terminal TWH 3 of the third modification, in the crimp terminal 3, the third seal portion 143 of the seal member 14 is disposed away from the end edge 31b of the barrel section 31 intersecting the covered portion W12. Therefore, in the terminal connection method of the third modification, the placing step of placing the end portion W1a of the covered portion W12 on the inner surface 31a of the barrel section 31 is the following process. That is, in the placing step in the third modification, the end portion W1a is placed so that the covered portion W12 directly contacts the inner surface 31a of the barrel section 31 in between the seal member 14 and the end edge 31b of the barrel section 31.

On the other hand, similarly to the above-described embodiment, the tip end W11a of the aluminum core wire W11 overlaps with the second seal portion 142, the tip end W12a of the covered portion W12 overlaps with the third seal portion 143, and the exposed portion of the aluminum core wire W11 contacts the first indent portion 117a. Further, also similarly to the above-described embodiment, the second seal portion 142 is formed like a band with a width such that a portion of the second seal portion 142 is extruded from the opening 11b of the barrel section 11 after crimping, and the first seal portion 141 is formed to have a width and shape corresponding to the groove section 116.

According to this third modification, it is needless to say that difficulty in manufacturing can be alleviated while securing waterproofness against the contact portion with the aluminum core wire W11 similar to the above-described embodiment. In addition, the point that the conductivity can be sufficiently secured and the point that the return of the barrel portion 31 can be suppressed well are also similar to the above-described embodiment.

Furthermore, according to the third modification, the portion between the third seal portion 143 of the seal member 14 and the end edge 31b of the barrel section 31 is in direct contact with the covered portion W12 and crimped. This makes it possible to improve the fixing force of the barrel section 31 to the covered portion W12 that is easy to move, for example, at the time of use and which is easily subjected to a force.

Next, three modifications to the groove section 116 in the barrel section 11 will be described as fourth to sixth modifications to the above-described embodiment.

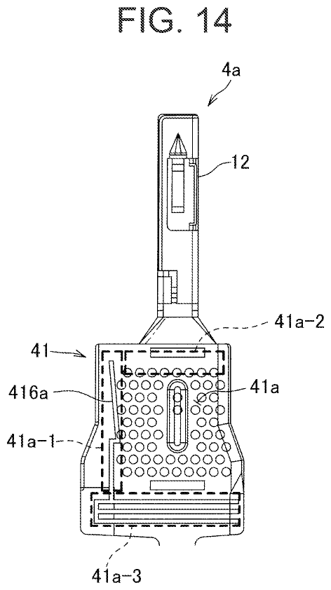

FIG. 14 is a view showing a fourth modification of the embodiment shown in FIGS. 1 to 10, FIG. 15 is a view showing a fifth modification of the embodiment shown in FIGS. 1 to 10, and FIG. 16 is a view showing a sixth modification of the embodiment shown in FIGS. 1 to 10. Incidentally, in these FIGS. 14 to 16, the crimp terminal in a state where the seal member is removed is shown so that the groove section in each modification can be seen.

In the crimp terminal 4a of the fourth modification shown in FIG. 14, the groove section 416a of the barrel section 41 is provided in the first region 41a-1 and the third region 41a-3 on the inner surface 41a, and not provided in the second region 41a-2. The shape of the groove section 416a in the first region 41a-1 and the third region 41a-3 is the same as the groove section 116 in the above-described embodiment.

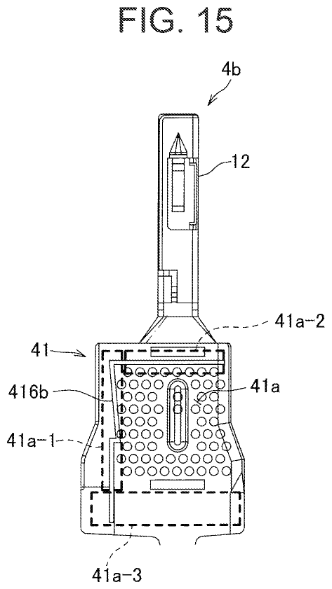

In the crimp terminal 4b of the fifth modification shown in FIG. 15, the groove section 416b of the barrel section 41 is provided in the first region 41a-1 and the second region 41a-2 on the inner surface 41a, and is not provided in the third region 41a-3 other than the extension from the first region 41a-1. The shape of the groove section 416b in the first region 41a-1 and the second region 41a-2 is the same as the groove section 116 in the above-described embodiment.

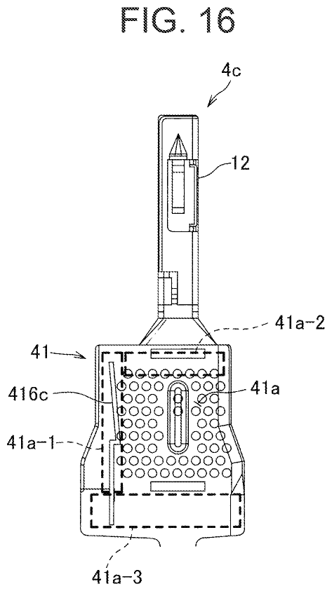

In the crimp terminal 4c of the sixth modification shown in FIG. 16, the groove section 416c of the barrel section 41 is provided in the first region 41a-1 on the inner surface 41a and is not provided in the second region 41a-2. Furthermore, the groove section 416c is not provided in the third region 41a-3 other than the extension from the first region 41a-1. The shape of the groove section 416c in the first region 41a-1 is the same as the groove section 116 in the above-described embodiment.

In any of these fourth to sixth modifications, as in the above-described embodiment, the seal member 14 is affixed and crimped to the end portion W1a of the covered electric wire W1. As a result, it is needless to say that difficulty in manufacturing can be alleviated while securing waterproofness against the contact portion with the aluminum core wire W11 similar to this embodiment. In addition, the point that the conductivity can be sufficiently secured and the point that the return of the barrel sections 41, 51, 61 can be satisfactorily suppressed are also similar to the above-described embodiment.

Next, five modifications to the seal member 14 will be described as seventh to eleventh modifications to the above-described embodiment.

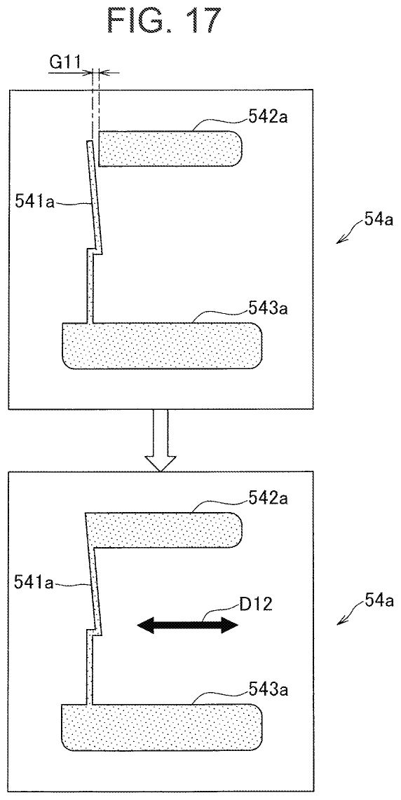

FIG. 17 is a view showing a seventh modification of the embodiment shown in FIGS. 1 to 10, FIG. 18 is a view showing an eighth modification of the embodiment shown in FIGS. 1 to 10, FIG. 19 is a view showing a ninth modification of the embodiment shown in FIGS. 1 to 10, FIG. 20 is a view showing a tenth modification of the embodiment shown in FIGS. 1 to 10, and FIG. 21 is a view showing a eleventh modification of the embodiment shown in FIGS. 1 to 10.

In the seal member 54a of the seventh modification shown in FIG. 17, the second seal portion 542a is divided from the first seal portion 541a, but the third seal portion 543a is connected to the first seal portion 541a. The shape of each seal portion is substantially the same as each seal portion of the seal member 14 in the above-described embodiment. In the seal member 54a according to the seventh modification, the second seal portion 542a is extended in the crossing direction D12 that coincides with the length direction thereof during crimping. Due to this extension, the second seal portion 542a is connected to the first seal portion 541a, and a gap G11 therebetween is blocked.

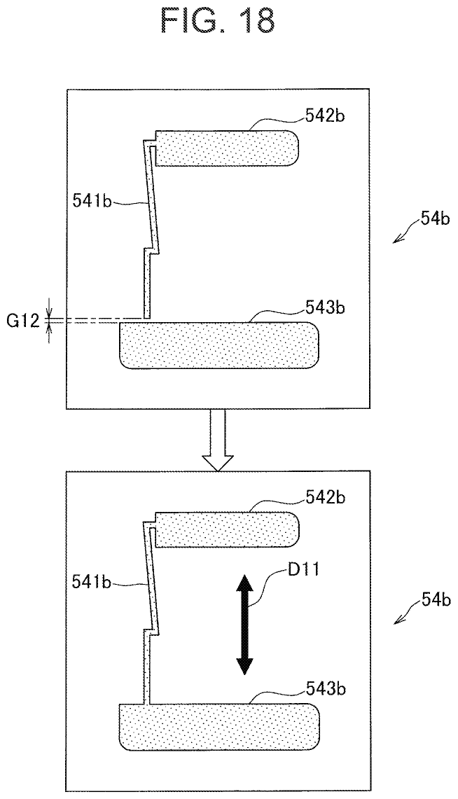

In the seal member 54b in the eighth modification shown in FIG. 18, the third seal portion 543b is divided from the first seal portion 541b, but the second seal portion 542b is connected to the first seal portion 541b. The shape of each seal portion is substantially the same as each seal portion of the seal member 14 in the above-described embodiment. In the seal member 54b according to the eighth modification, the first seal portion 541b is extended in the axial direction D11 that coincides with the length direction thereof during crimping. Due to this extension, the first seal portion 541b is connected to the third seal portion 543b, and a gap G12 therebetween is blocked.

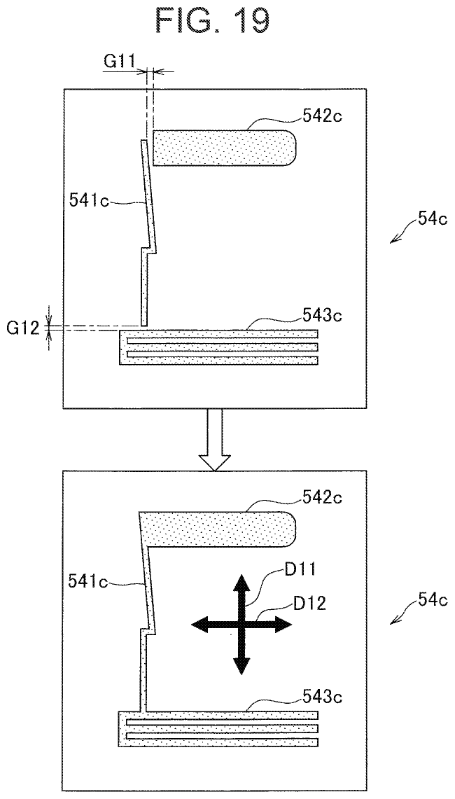

In the seal member 54c in the ninth modification shown in FIG. 19, the third seal portion 543c has the following shape. That is, the third seal portion 543c is formed in a width and shape corresponding to the groove section 116 in the third region 11a-3 shown in FIG. 2. Specifically, the third seal portion 543c is formed to have substantially the same width and shape as the groove section 116 so as to be accommodated in the groove section 116. Further, both the second seal portion 542c and the third seal portion 543c are divided from the first seal portion 541c. The shapes of the first seal portion 541c and the second seal portion 542c are substantially the same as those of the seal member 14 in the above-described embodiment. In the seal member 54c according to the ninth modification, the second seal portion 542c is extended in the crossing direction D12 that coincides with the length direction thereof during crimping. Due to this extension, the second seal portion 542c is connected to the first seal portion 541c, and the gap G11 therebetween is blocked. Also, the first seal portion 541c is extended in the axial direction D11 that coincides with the length direction thereof. Due to this extension, the first seal portion 541c is connected to the third seal portion 543c, and the gap G12 therebetween is blocked.

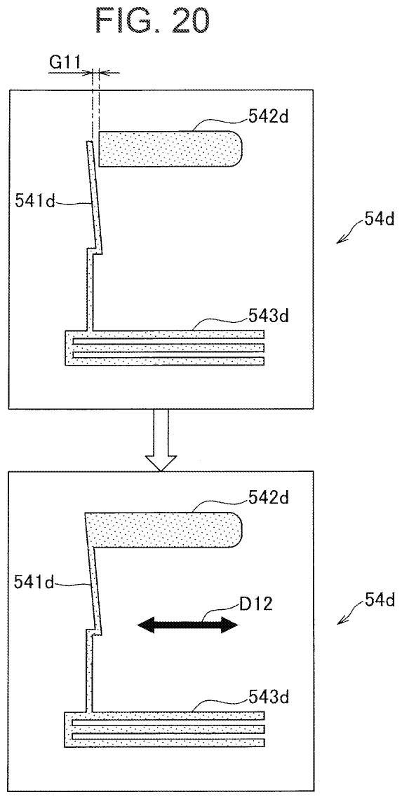

The seal member 54d in the tenth modification shown in FIG. 20 is a further modification of the seal member 54c in the ninth modification shown in FIG. 19. That is, in the seal member 54d in the tenth modification, the second seal portion 542d is divided from the first seal portion 541d, but the third seal portion 543d is connected to the first seal portion 541d. On the other hand, the shape of each seal portion is substantially the same as each seal portion of the seal member 54c in the above-described ninth modification. In the seal member 54d according to the tenth modification, the second seal portion 542d is extended in the crossing direction D12 that coincides with the length direction thereof during crimping. Due to this extension, the second seal portion 542d is connected to the first seal portion 541d, and the gap G11 therebetween is blocked.

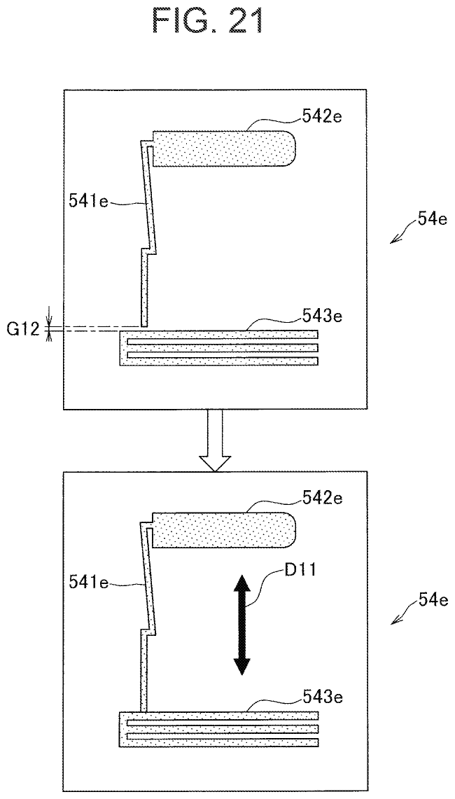

The seal member 54e in the eleventh modification shown in FIG. 21 is also a further modification of the seal member 54c in the ninth modification shown in FIG. 19. That is, in the seal member 54e of the eleventh modification, the third seal portion 543e is divided from the first seal portion 541e, but the second seal portion 542e is connected to the first seal portion 541e. On the other hand, the shape of each seal portion is substantially the same as each seal portion of the seal member 54c in the above-described ninth modification example. In the seal member 54e in the eleventh modification, the first seal portion 541e is extended in the axial direction D11 that coincides with the length direction thereof during crimping. Due to this extension, the first seal portion 541e is connected to the third seal portion 543e, and the gap G12 therebetween is blocked.

In any of these seventh to eleventh modifications, the seal members 54a, 54b, 54c, 54d, 54e are affixed to the barrel section 11 and crimped to the end portion W1a of the covered electric wire W1 similar to the above embodiment. As a result, it is needless to say that difficulty in manufacturing can be alleviated while securing waterproofness against the contact portion with the aluminum core wire W11 similar to the above embodiment. In addition, the point that the conductivity can be sufficiently secured and the point that the return of the barrel portion 11 can be satisfactorily suppressed are also the same as the above embodiment.

Further, regarding the ninth to eleventh modifications in which the third seal portions 543c, 543d, 543e are formed in the width and shape corresponding to the groove section 116 in the third region 11a-3, it is furthermore possible to obtain the following advantages. According to these ninth to eleventh modifications, each amount of third seal portions 543c, 543d, and 543e is also minimized. As a result, the barrel section 11 is hermetically sealed while further preventing interference of crimping by the sealing members 54c, 54d, 54e, which further alleviates difficulties in manufacturing.

Next, as a twelfth to fourteenth modifications to the above-described embodiment, three modifications to the concave section 114 having a circular shape in a plan view provided on the inner surface 11a of the barrel section 11 will be described.

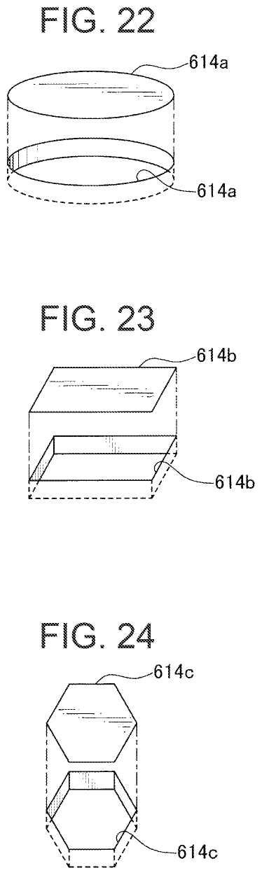

FIG. 22 is a view showing a twelfth modification of the embodiment shown in FIGS. 1 to 10, FIG. 23 is a view showing a thirteenth modification of the embodiment shown in FIGS. 1 to 10, and FIG. 24 is a view showing a fourteenth modification of the embodiment shown in FIGS. 1 to 10.

The concave section 614a in the twelfth modification shown in FIG. 22 is formed in an elliptical shape in plan view. In addition, the concave section 614b in the thirteenth modification shown in FIG. 20 is formed in a parallelogram in a plan view. Further, the concave section 614c in the fourteenth modification shown in FIG. 21 is formed in a hexagonal shape in plan view.

Besides these, as a modification of the concave section 114 in the crimp terminal 1 of the above-described embodiment, a triangle or another polygon in plan view and the like can be presented. In any of these modifications, for example, as compared with a linear groove extending in the crossing direction D12 which may be employed as a conventional serration, the resistance against the force to expand in the in-plane direction of the inner surface 11a is strong.

Four modifications of the seal member 14 will be described as fifteenth to eighteenth modifications to the above-described embodiment.

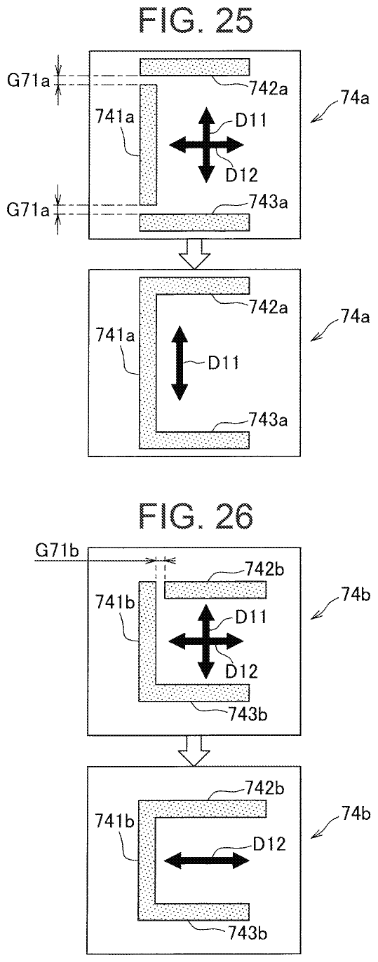

FIG. 25 is a view showing a fifteenth modification of the embodiment shown in FIGS. 1 to 10, FIG. 26 is a view showing a sixteenth modification of the embodiment shown in FIGS. 1 to 10, FIG. 27 is a view showing a seventeenth modification of the embodiment shown in FIGS. 1 to 10, and FIG. 28 is a view showing a eighteenth modification of the embodiment shown in FIGS. 1 to 10.

In the seal member 74a of the fifteenth modification shown in FIG. 25, the first seal portion 741a is a portion extending in a band shape in the axial direction D11 in the first region 11a-1. The second seal portion 742a is a portion extending in a band shape in the crossing direction D12 in the second region 11a-2. The third seal portion 743a is a portion extending in a band shape in the crossing direction D12 in the third region 11a-3. Further, both the second seal portion 742a and the third seal portion 743a are divided from the first seal portion 741a. Further, both the second seal portion 742a and the third seal portion 743a are divided from the first seal portion 741a by a gap G71a crossing the path 11a-4 shown in FIG. 2 in the crossing direction D12. The first seal portion 741a, the second seal portion 742a, and the third seal portion 743a are affixed to the barrel section 11 so as to overlap with the groove section 116. In the seal member 74a in the fifteenth modification, the first seal portion 741a is extended in the axial direction D11 that coincides with the length direction thereof during crimping. Due to this extension, the first seal portion 741a is connected to both the second seal portion 742a and the third seal portion 743a, and each gap G71a is blocked.

The seal member 74b in the sixteenth modification shown in FIG. 26 is a further modification of the seal member 74a in the fifteenth modification shown in FIG. 25. That is, in the seal member 74b of the sixteenth modification, the second seal portion 742b is divided from the first seal portion 741b, but the third seal portion 743b is connected to the first seal portion 741b. Further, in the sixteenth modification, the second seal portion 742b is divided from the first seal portion 741b by a gap G71b across the path 11a-4 in the axial direction D11. In the seal member 74b according to the sixteenth modification, the second seal portion 742b is extended in the crossing direction D12 that coincides with the length direction thereof during the crimping. Due to this extension, the second seal portion 742b is connected to the first seal portion 741b, and the gap G71b therebetween is blocked.

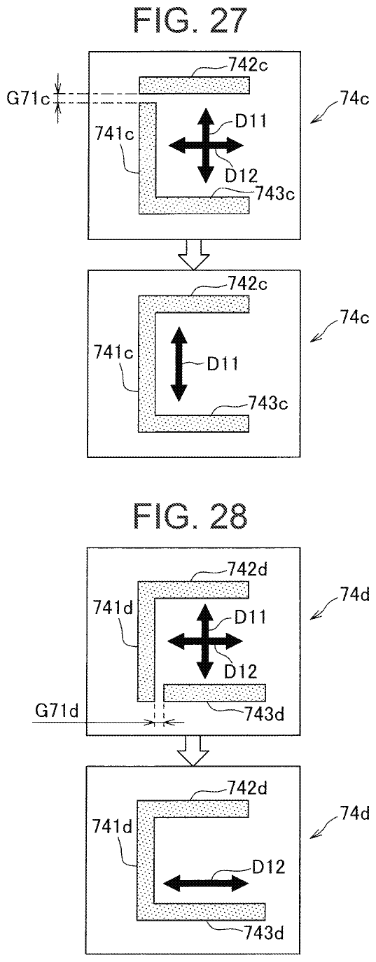

The seal member 74c in the seventeenth modification shown in FIG. 27 is also a further modification of the seal member 74b in the fifteenth modification shown in FIG. 25. That is, in the seal member 74c of the seventeenth modification, the second seal portion 742c is divided from the first seal portion 741c, but the third seal portion 743c is connected to the first seal portion 741c. Further, in the seventeenth modification, the second seal portion 742c is divided from the first seal portion 741c by a gap G71c across the path 11a-4 in the crossing direction D12. In the seal member 74c according to the sixteenth modification, the first seal portion 741c is extended in the axial direction D11 during crimping. Due to this extension, the first seal portion 741c is connected to the second seal portion 742c, and the gap G71c therebetween is blocked.

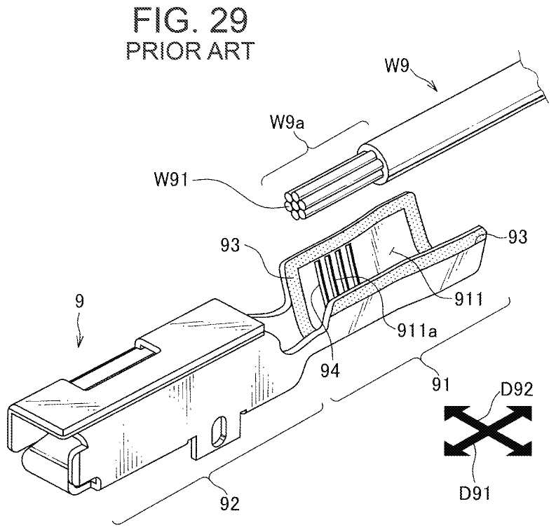

The sealing member 74d in the eighteenth modification shown in FIG. 28 is also a further modification of the sealing member 74b in the fifteenth modification shown in FIG. 25. That is, in the seal member 74d of the eighteenth modification, the third seal portion 743d is divided from the first seal portion 741d, but the second seal portion 742d is connected to the first seal portion 741d. Further, in the eighteenth modification, the third seal portion 743d is divided from the first seal portion 741d by a gap G71d traversing the path 11a-4 in the axial direction D11. In the seal member 74d in the sixteenth modification, the third seal portion 743d is extended in the crossing direction D12 during crimping. Due to this extension, the third seal portion 743d is connected to the first seal portion 741d, and the gap G71d therebetween is blocked.

Compared with the fifteenth to the eighteenth modifications, in the above-described embodiment, the first seal portion 141 is formed in a width and a shape corresponding to the groove section 116, and the amount thereof is suppressed, so that manufacturing difficulties can be alleviated as described above.

On the other hand, also in these fifteenth to eighteenth modifications, for example, as shown in FIG. 5, it goes without saying that by crimping to the covered electric wire W1, it is possible to sufficiently secure the conductivity, and the return of the barrel section 31 can be well suppressed similar to the above-described embodiment.

It is to be noted that the above-described embodiment merely shows a representative form of the present invention, and the present invention is not limited to this embodiment. That is, various modifications can be made without departing from the gist of the present invention. As long as the configuration of the present invention is still provided by such modification, it is of course within the scope of the present invention.

For example, in the above-described embodiment and various modified examples, a mode in which a convex section is provided on the barrel section by press working from the outer surface side is exemplified. However, the barrel section is not limited to this form, and the convex section may be omitted. However, as described above, by providing the convex section, it is possible to increase the number of contacts with the barrel section by spreading the strands of the aluminum core wire.

Further, in each of the above-described embodiments and the various modifications, as one example of the terminal section, a crimp terminal having a terminal section 12 as a female terminal in a square tubular shape is exemplified. However, the terminal section is not limited to this, and does not require any specific shape or connection mode.

### REFERENCE SIGNS LIST

1, 2, 3, 4a, 4b, 4c Crimp terminal
11, 21, 31, 41 Barrel section
11a, 31a, 41a Inner surface
11a-1, 41a-1 First region
11a-2, 41a-2 Second region
11a-3, 41a-3 Third region
11a-4, 41a-4 Path
12 Terminal section
14, 54a, 54b, 54c, 54d, 54e, 74a, 74b, 74c, 74d Sealing member
111 Bottom plate section
112 Inner barrel piece
113 Outer barrel piece
114, 614a, 614b, 614c Concave section
115 Convex section
116, 416a, 416b, 416c Groove section
117a first indent portion (ridge portion)
117b second indent portion (second ridge portion)
141, 541a, 541b, 541c, 541d, 541e, 741a, 741b, 741c, 741d First seal portion
142, 542a, 542b, 542c, 542d, 542e, 742a, 742b, 742c, 742d Second seal portion
143, 543a, 543b, 543c, 543d, 543e, 743a, 743b, 743c, 743d Third seal portion
D11 Axial direction
D12 Crossing direction
G11, G12, G71a, G71b, G71c, G71d Gap
W1 Covered electric wire
W1a End portion
W11 Aluminum core wire
W11a Tip end
W12 Covered portion
W12a Tip end
TW1, TWH1, TWH2, TWH3 wire with terminal

1. An electric wire with terminal of which an end portion is connected to a crimp terminal in which a barrel section to be wound around and crimped to an end portion of a covered electric wire having an aluminum core wire at which the aluminum core wire is exposed, and a terminal section to be connected to a connection object are arranged in a predetermined axial direction,
wherein the barrel section includes: a bottom plate section extending in the axial direction, on which the end portion of the covered electric wire is to be placed; and an inner barrel piece and an outer barrel piece extending from the bottom plate portion on both sides in a crossing direction intersecting the axial direction in plan view with respect to the bottom plate portion,
wherein a sealing member formed of an adhesive gel is affixed across a first region that longitudinally traverses the outer barrel piece in the axial direction, a second region which traverses the inner surface in the crossing direction at a position close to the terminal section, and a third region that traverses the inner surface in the crossing direction so as to intersect a covered portion of the end portion,
wherein a plurality of concave sections is dispersedly provided on an inner surface of the barrel section, a groove section is provided on at least the third region so as to overlap the sealing member, and a ridge portion is provided extending in the crossing direction at a position which does not overlap with the sealing member in plan view and is close to the third region,
wherein the barrel section is crimped to the end portion by crimping so that the exposed portion of the aluminum core wire at the end portion is in contact with the ridge portion, and the sealing member seals between the inner barrel piece and the outer barrel piece, an opening of the barrel section which is to be cylindrical on a side of the terminal section, and between the covered portion and the barrel section.

2. The electric wire with terminal as claimed in claim 1,
wherein the inner surface of the barrel section is further provided with a second ridge portion extending in the crossing direction at a position close to the terminal section.

3. The electric wire with terminal as claimed in claim 1,
wherein the barrel section is crimped to the end portion so that a tip of the covered portion at the end portion overlaps a portion of the sealing member affixed to the third region.

4. The electric wire with terminal as claimed in claim 1,
wherein the groove section is also provided on the first region so as to overlap the sealing member, and
wherein in the seal member, a first seal portion affixed to the first region is narrower than a second seal portion affixed to the second region, and formed in a shape corresponding to the groove section in the first region.

5. A terminal connection method for connecting a crimp terminal to an end portion of a covered electric wire to obtain the electric wire with terminal as claimed in claim 1,
the method comprising:
a placing step of placing the end portion on the inner surface of the barrel section along the axial direction so that an exposed portion of the aluminum core wire at the end portion is in contact with the ridge portion; and
a crimping step of fixing the crimp terminal to the end portion by winding the barrel section around the end portion with the inner barrel piece arranged inside and by crimping, and sealing between the inner barrel piece and the outer barrel piece, an opening of the barrel section which is to be cylindrical on a side of the terminal section, and between the covered portion and the barrel section with the sealing member.

6. The terminal connection method as claimed in claim 5,
wherein the placing step is a step of placing the end portion on the inner surface of the barrel section so that a tip of the covered portion at the end portion overlaps with a portion of the sealing member affixed to the third region.

7. The terminal connection method as claimed in claim 5,
wherein the groove section is also provided on the first region so as to overlap the sealing member, and
wherein in the seal member, a first seal portion affixed to the first region is affixed so as to be accommodated inside the groove section in the first region.
